(19) United States
(12) Patent Application Publication
(10) Pub. No.: US 2008/0296824 A1
(43) Pub. Date: Dec. 4, 2008

(54) Custom Cutting and Utility Board

(76) Inventor: Edward R. Griffin, JR., Brookshire, TX (US)

Correspondence Address: KEELING PATENTS AND TRADEMARKS, 3310 KATY FREEWAY, SUITE 100, HOUSTON, TX, 77007, US

(21) Appl. No.: 11/757,486

(22) Filed: Jun. 4, 2007

(51) Int. Cl. B23Q 3/00

(52) U.S. Cl. 269/291

(57) ABSTRACT

There is provided a custom cutting and utility board for supporting and laterally securing building materials while carpentry work is performed on the materials. The utility board includes two board sides hingedly attached at their ends for pivotal movement between an open, cutting board position and a folded, closed position. Guide blocks are attached to the upper surfaces of the board sides. The guide blocks are positioned in a staggered arrangement with respect to each other so that when the board sides are folded together, the guide blocks on opposite utility board sides lie between one another. The guide blocks define channels therebetween for receiving and retaining predetermined sizes of building material while the work is performed thereon. The hinges are segmented and sized so that mating edges of the board sides abut each other when the board is in its open, cutting board position, and lie parallel to each other when the utility board is in its folded, closed position. Oval shaped hand openings are provided in the board sides for facilitating carrying the utility board in its folded, closed position. Straps are attached to the utility board for securing a load or injured worker to the utility board in its folded, closed position.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

1. Field of the Invention

The present invention relates generally to carpenter's guides, and, more specifically, to a portable folding utility board having a plurality of guides for receiving and retaining common widths of construction materials.

2. Description of the Related Art

In the building construction trade, carpenters frequently saw lumber at the job site for installation on the building. The lumber used is generally provided in standard thicknesses and widths, such as nominal 1″×2″, 1″×6″, 1″×8″, 2″×4″, 2″×6″, 2″×8″, and 2″×12″ sizes. To obtain accurate cuts, the lumber must be held or fastened securely while cutting, and preferably in a horizontal position. Quite often, the lumber is placed on sawhorses or the like for supporting it while measuring, marking, and sawing. However, sawhorses do not provide lateral support to the lumber to prevent lateral movement during these operations. A need therefore exists for a device for laterally supporting standard sizes of lumber while preparing for and cutting the lumber at a construction site. Preferably, such a device will be foldable, portable, and easily carried from site to site where needed. Still more preferably, the device will also function as a platform or backboard for transporting building materials, tools, or an injured worker.

### BRIEF SUMMARY OF THE INVENTION

The present invention addresses the aforementioned needs. According to one embodiment of the invention, a custom cutting and utility board is provided for measuring, supporting, and cutting building materials, such as lumber. A plurality of guide blocks are fixedly attached to the top surface of the utility board, with most of the guide blocks configured in pairs. Each pair of guide blocks is adjacently positioned to provide a space between the pair of guide blocks. The space corresponds to standard or nominal dimensions of building materials, such as the standard widths of precut lumber.

A pivot line runs longitudinally along the center of the utility board, thereby providing a means for folding the utility board into a closed position. When the utility board is folded into the closed position, it provides a backboard for supporting a load of weight, such as building materials, tools or an injured worker. The utility board provides a plurality of grasping openings along the perimeter of the folded utility board, thereby providing means for carrying the folded utility board horizontally. The grasping openings preferably align when the utility board is in the folded position. In one embodiment, a pair of hinges are attached to the opposite ends of the utility board, thereby providing means for opening and closing the utility board.

Other objects of the invention are apparent from the following description, the claims set forth below, and the accompanying drawings.

### BRIEF DESCRIPTION OF THE DRAWINGS

For a more complete understanding of the present invention and the advantages thereof, reference is now made to the following Description of an Example Embodiment of the Invention, taken in conjunction with the accompanying drawings, in which:

FIG. 1 is a perspective view of the utility board of the present invention in the open, cutting board position.

FIG. 2 is a perspective view of the utility board of FIG. 1 in the closed position.

FIG. 3 is a top view of the segmented hinge of the invention.

FIG. 4 is a side elevation view of the segmented hinge.

FIG. 5 is an end view of a portion of the utility board in the open position, showing the segmented hinge attached thereto.

FIG. 6 is an end view of a portion of the utility board in the closed position, showing the segmented hinge attached thereto.

### DESCRIPTION OF AN EXAMPLE EMBODIMENT OF THE INVENTION

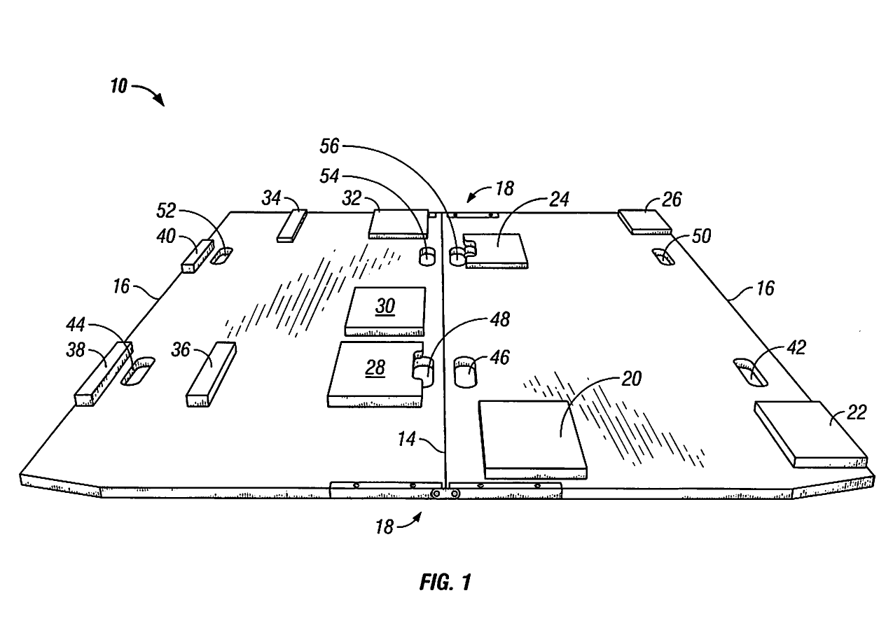

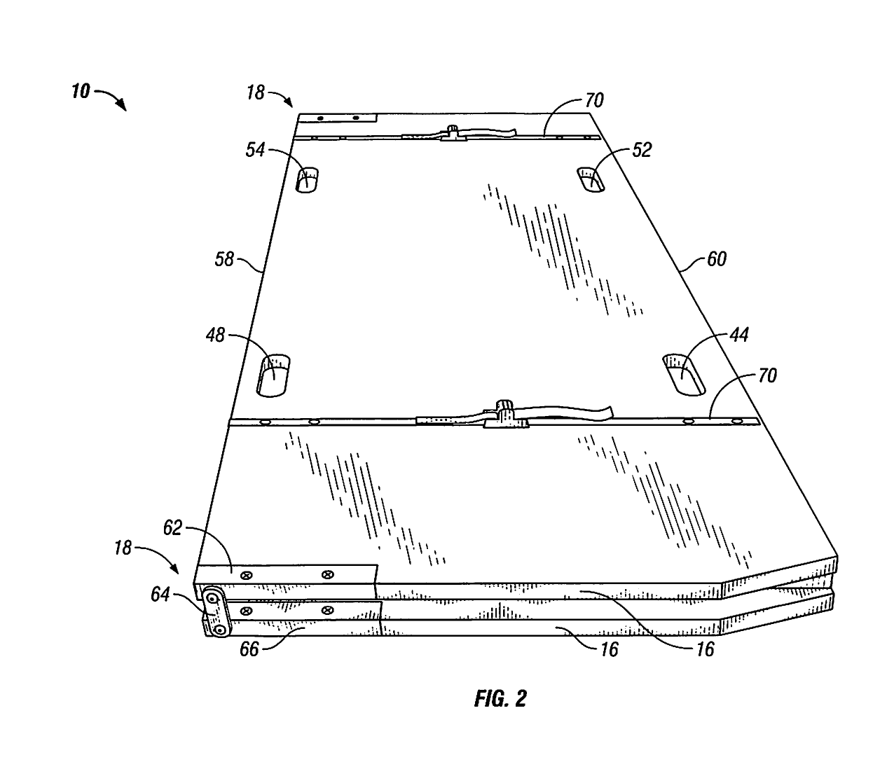

The invention and its advantages are best understood by referring to the drawings, like numerals being used for like and corresponding parts of the various drawings. Referring to FIG. 1, an example embodiment of the folding utility board, generally designated 10, is depicted in the open position. Utility board 10 is useful for measuring, supporting, and cutting building materials, such as lumber (not depicted). Utility board 10 pivots along center line 14, which allows the two opposing sides 16 of utility board 10 to fold together into a backboard configuration, as seen in FIG. 2.

Referring to FIG. 1, utility board 10 of the present invention is depicted in an open position. Utility board 10 includes two board sides 16 that are connected together by segmented or 2-axis hinges 18 attached to the opposite ends of sides 16. Segmented hinges 18 allow utility board 10 to be opened as seen in FIG. 1, or folded closed as seen in FIG. 2. In one embodiment of the invention, utility board sides 16 comprise ¾ inch thick plywood. However, it will be understood that various materials may be used for utility board 10, and that the invention is not limited to any particular materials of construction. When used for measuring, supporting, or cutting building materials, utility board 10 may be supported by saw horses (not illustrated) or on any flat surface, such as a concrete floor or driveway.

A plurality of guide blocks 20, 22, 24, 26, 28, 30, 32, 34, 36, 38, and 40 are attached to the upper surfaces of utility board sides 16, and define a plurality of channels for receiving and retaining various sizes of lumber. Generally, utility board 10 provides linear stability for lumber placed in the channels while it is being sawed, nailed, or other work is being performed on the lumber during the construction process. In the embodiment illustrated in FIG. 1, blocks 20, 22, 24, and 26 form a channel that is sized to accommodate a nominal 12 inch wide board. Blocks 20, 28, 30, 24, and 32 form a channel that is sized to accommodate a nominal 4 inch wide board. Blocks 28, 30, 32, 34, and 36 form a channel that is sized to accommodate a nominal 8 inch wide board. Blocks 36, 34, 38, and 40 form a channel that is sized to accommodate a nominal 6 inch wide board. Accordingly, boards of different sizes may be conveniently inserted in the appropriate channel to be retained for sawing, cutting, nailing, or other operations.

Eight through openings 42, 44, 46, 48, 50, 52, 54, and 56, generally oval shaped and sized to accommodate a worker's hand, are provided in utility board 10. In the folded position, openings 42 and 44 are adjacent, openings 46 and 48 are adjacent, openings 50 and 52 are adjacent, and openings 54 and 56 are adjacent. When carrying utility board 10, the worker places his hand through both of the adjacent openings. As seen in FIG. 2, a pair of hand holds formed by openings 46, 48 and 54, 56 are located on the hinged side 58 of the folded utility board 10. Another pair of hand holds formed by openings 42, 44, and 50, 52 are located on the opposite side 60 of the folded utility board 10.

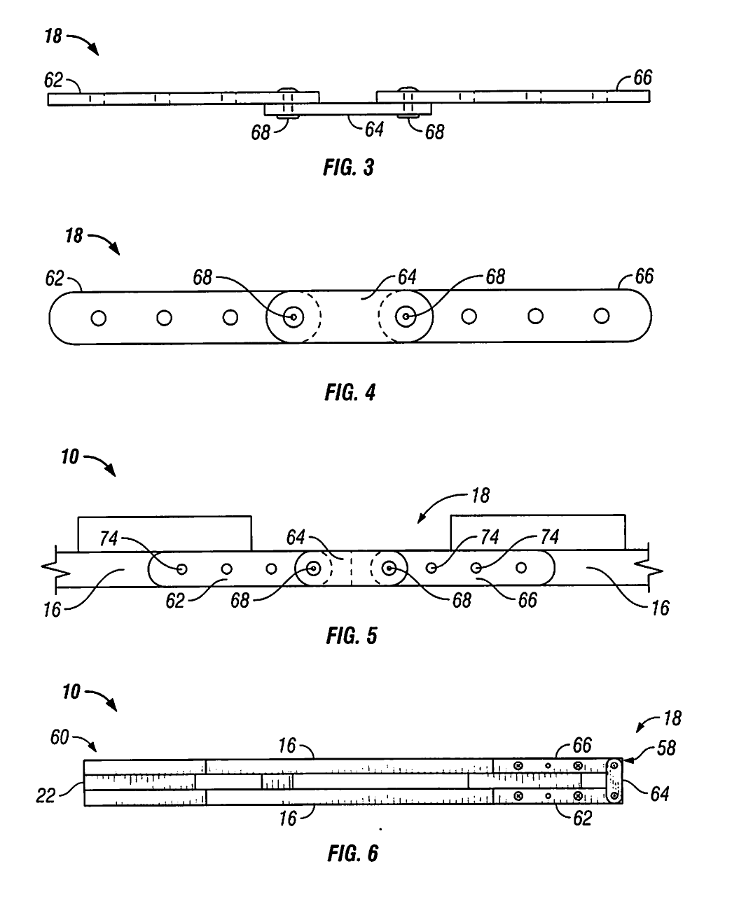

Referring to FIGS. 3 and 4, each segmented hinge 18 is made up of a left hinge segment 62, a middle hinge segment 64, and a right hinge segment 66. Middle hinge segment 64 is rotatably connected to left hinge segment 62 and to right hinge segment 66 by rivets 68 or other suitable fasteners.

A segmented hinge 18 is attached at each end of utility board 10. Left hinge segment 62 is attached to the left utility board side 16, and right hinge segment 66 is attached to right utility board side 16 by screws 74 or other suitable fasteners. FIG. 5 illustrates a portion of the end of utility board 10 in the open position, showing segmented hinge 18 attached to the utility board sides 16. FIG. 6 illustrates an end of utility board 10 in the closed position, showing the U-shaped configuration of segmented hinge 18 when utility board 10 is closed. When utility board 10 is closed and lying horizontally, middle hinge segment 64 is vertically oriented, and forms a 90 degree angle with left hinge segment 62 and with right hinge segment 66. Segmented hinge 18 is sized in relation to the thicknesses of utility board sides 16 and of the guide blocks so that the mating edges of utility board sides 16 abut each other along center line 14 when folding utility board 10 is open, as seen in FIG. 1, and so that utility board sides 16 lie parallel to each other when utility board 10 is closed, as seen in FIGS. 2 and 6. Guide blocks 20, 22, 24, 26, 28, 30, 32, 34, 36, 38, and 40 are positioned in a staggered arrangement on the surfaces of utility board sides 16 so that when utility board sides 16 are folded together, the guide blocks on the opposite utility board sides lie between one another so as to permit complete closure of utility board 10. It will be observed that the overall thickness of utility board 10 is the combined thickness of the two board sides 16 and of the guide blocks 20, 22, 24, 26, 28, 30, 32, 34, 36, 38, and 40.

Advantageously, in the folded or closed position, utility board 10 may be used as a backboard for transporting materials, tools, or an injured worker. The handholds formed by openings 42, 44, 46, 48, 50, 52, 54, and 56 allow for convenient handling by two or four persons when utility board 10 is being used as a backboard. Straps 70 may be used to secure the load or injured worker to the utility board while in transit. In one example embodiment, straps 70 are provided with quick-release buckles (not illustrated), similar to automotive seat belt buckles, to permit faster unloading of utility board 10. Advantageously, guide blocks 22 and 26 are positioned at the corners of folded utility board 10, guide blocks 38 and 40 are positioned at the edge of utility board 10 opposite the hinges, and the remaining guide blocks 20, 24, 28, 30, 32, 34, and 36 are positioned at intermediate areas of utility board 10 so as to provide optimum support to the upper board side when the utility board is used as a carrying device.

The custom cutting and utility board of the present invention, and many of its intended advantages, will be understood from the foregoing description of an example embodiment, and it will be apparent that, although the invention and its advantages have been described in detail, various changes, substitutions, and alterations may be made in the manner, procedure, and details thereof without departing from the spirit and scope of the invention, as defined by the appended claims, or sacrificing any of its material advantages, the forms hereinbefore described being merely an exemplary embodiment thereof.

1. A utility board for supporting and laterally securing building materials while work is performed on the materials, the utility board comprising:
at least two board sides, each side having an upper surface and a lower surface;
at least one hinge connecting the board sides for pivotal movement between an open, cutting board position and a folded position;
a plurality of guide blocks attached to the upper surface of at least one of the board sides, the plurality of guide blocks defining at least one channel therebetween for receiving and retaining a predetermined size of building material while the work is performed thereon.

2. The utility board of claim 1, comprising first and second board sides, wherein guide blocks are attached to the upper surfaces of the first and second board sides,
said guide blocks of said left board side positioned in a staggered arrangement in relation to the guide blocks of said right board side so that when the board sides are in said folded position, the guide blocks of said first board side lie between the guide blocks of said second board side.

3. The utility board of claim 2, wherein the board sides have opposite ends, and wherein the hinges connecting the board sides are attached to respective ends of the board sides.

4. The utility board of claim 3, wherein the hinges are segmented hinges.

5. The utility board of claim 4, wherein each segmented hinge comprises:
a first hinge segment attached to the first board side;
a second hinge segment attached to the second board side; and
a third hinge segment rotatably connected to the first hinge segment and to the second hinge segment.

6. The utility board of claim 5, wherein the segmented hinge forms a U-shaped configuration when the utility board is in the folded position.

7. The utility board of claim 5, wherein the segmented hinge is sized in relation to the thicknesses of the board sides and of the guide blocks so that the mating edges of the first and second board sides abut each other when the utility board is in its open, cutting board position, and so that the first and second board sides lie parallel to each other when the utility board is in its folded position.

8. The utility board of claim of claim 1, wherein the board sides have at least one hand opening therethrough.

9. The utility board of claim 8, comprising two board sides, wherein each board side has at least one pair of hand openings therein.

10. The utility board of claim 9, wherein each board side has two pairs of hand openings therein.

11. The utility board of claim 10, wherein the folded utility board has a hinged side and an opposite side, and wherein the hand openings are positioned so that:
a pair of through hand openings is formed on the hinged side of the folded utility board by adjacent hand openings in the board sides, and
another pair of through hand openings is formed on the opposite side of the folded utility board by adjacent hand openings in the board sides.

12. The utility board of claim 10, wherein the hand openings are generally oval shaped and sized to accommodate a worker's hand.

13. The utility board of claim 1, further including at least one strap attached to the utility board for securing a load or injured worker to the utility board in its folded position.

14. A utility board for supporting and laterally securing building materials while work is performed on the materials, the utility board comprising:
two board sides, each side having an upper surface and a lower surface and opposite ends;
a hinge attached to each respective end of the board sides for connecting the board sides for pivotal movement between an open, cutting board position and a folded position;
a plurality of guide blocks attached to the upper surface of at least one of the board sides, the guide blocks:
defining at least one channel therebetween for receiving and retaining a predetermined size of building material while the work is performed thereon; and
the guide blocks positioned in a staggered arrangement with respect to each other so that when the board sides are folded, the guide blocks on opposite utility board sides lie between one another so as to permit complete closure of the utility board.

15. The utility board of claim 14, wherein the hinges are segmented hinges.

16. The utility board of claim 15, comprising first and second board sides, and wherein each segmented hinge comprises:
a first hinge segment attached to the first board side;
a second hinge segment attached to the second board side; and
a third hinge segment rotatably connected to the first hinge segment and to the second hinge segment.

17. The utility board of claim 15, wherein the segmented hinge is sized in relation to the thicknesses of the board sides and of the guide blocks so that the mating edges of the first and second board sides abut each other when the utility board is in its open, cutting board position, and so that the board sides lie parallel to each other when the utility board is in its folded position.

18. The utility board of claim 14, wherein each board side has at least one pair of hand openings therein.

19. The utility board of claim 14, further including at least one strap attached to the utility board for securing a load or injured worker to the utility board in its folded position.

20. A utility board for supporting and laterally securing building materials while work is performed on the materials, the utility board comprising:
two board sides, each side having an upper surface and a lower surface and opposite ends and at least one pair of hand openings therein for facilitating carrying the utility board;
a plurality of guide blocks attached to the upper surface of at least one of the board sides, the guide blocks:
defining at least one channel therebetween for receiving and retaining a predetermined size of building material while the work is performed thereon; and
the guide blocks positioned in a staggered arrangement with respect to each other so that when the board sides are folded together, the guide blocks on opposite utility board sides lie between one another so as to permit complete closure of the utility board;
a segmented hinge attached to each respective end of the board sides for connecting the board sides for pivotal movement between an open, cutting board position and a folded position, the segmented hinge being sized in relation to the thicknesses of the board sides and of the guide blocks so that the mating edges of the board sides abut each other when the utility board is in its open, cutting board position, and so that the board sides lie parallel to each other when the utility board is in its folded position; and
at least one strap attached to the utility board for securing a load or injured worker to the utility board in its folded, closed position.
